(19) United States
(12) Patent Application Publication
(10) Pub. No.: US 2015/0338051 A1
(43) Pub. Date: Nov. 26, 2015

(54) Device for Securing Art Overlay to a Lighting Cover

(71) Applicant: Michael K. Thomas, Hot Springs, AR (US)

(72) Inventor: Michael K. Thomas, Hot Springs, AR (US)

(21) Appl. No.: 14/717,356

(22) Filed: May 20, 2015

Related U.S. Application Data
(63) Continuation-in-part of application No. 14/282,168, filed on May 20, 2014.

(51) Int. Cl. F21V 1/14; F21V 17/10; F21V 17/00

(52) U.S. Cl. CPC F21V 1/143; F21V 17/002; F21V 17/105

(57) ABSTRACT

A device for securing an art overlay to a lighting cover, such as a lampshade, barrel lamp, or sconce lamp, having a front panel designed to fit against the front of the lighting cover and complementary magnets attached to the inner surface of the lighting cover. The front panel is divided into two parallel panels which are liftable to position the overlay.

### CROSS-REFERENCE TO RELATED APPLICATIONS

This application is a continuation-in-part application of, and claims the benefit of, U.S. patent application Ser. No. 14/282,168, entitled “Device for Accessorizing Lamp Shades” and filed May 20, 2014. The disclosure of the above-referenced application is herein incorporated by reference in its entirety

### STATEMENT REGARDING FEDERALLY SPONSORED RESEARCH OR DEVELOPMENT

Not applicable

### BACKGROUND OF THE INVENTION

The present invention relates to a device for accessorizing lighting covers (e.g. lampshades) and, more particularly, to a holder for securing an art overlay to lighting covers. Whether one is moving into a new residence or having lived in the same residence for years, it is human nature to seek new or different surroundings. For most people, purchasing new furniture and fixtures every time they grow tired of their current ones is impossible because of financial restraints.

Regardless of the size of the residence, it is likely that somewhere within reach is a lamp or lighting fixture having a shade or a cover. Lamps and lamp shades come in myriad of colors and designs ranging from drab to spectacular. Even a most spectacular lamp or lampshade can become dull to a person, and they might find it refreshing and even stimulating to make a change. Buying a new lamp can be expensive and the task of changing a lamp shade is not without its complexities. Shades come in all sorts of shapes and sizes and are usually intended to fit a particular lamp or lighting device. Thus, one cannot always get the exact pattern and shape that fits a particular lighting device for which a change is sought.

The limitations of the prior art are overcome by the present invention as described below.

### BRIEF SUMMARY OF THE INVENTION

The present invention is directed to device for securing an art overlay to a lighting cover including: (a) a front panel configured for positioning on the outside surface of a lighting cover, wherein the front panel includes a first subpanel and second subpanel, wherein a first magnet is attached to the first subpanel and a second magnet is attached to the second subpanel, wherein the front panel is liftable to secure an art overlay to a lighting cover; (b) a third magnet, wherein the third magnet is complementary to the first magnet, wherein the third magnet is configured for attachment to an inside surface of a lighting cover; and (c) a fourth magnet, wherein the fourth magnet is complementary to the second magnet, wherein the fourth magnet is configured for attachment to an inside surface of the lighting cover.

These and other features, objects and advantages of the present invention will become better understood from a consideration of the following detailed description of the preferred embodiments and appended claims in conjunction with the drawings as described following:

### BRIEF DESCRIPTION OF THE DRAWINGS

FIG. 1 is a perspective view of the device of the first preferred embodiment.

FIG. 2 is a front view of the device of the first preferred embodiment.

FIG. 3 is a perspective view of a lampshade having an art overlay being held in place by the device of the first preferred embodiment.

FIG. 4 is an enlarged perspective view of a lampshade with the device of the first preferred embodiment.

FIG. 5 is an enlarged perspective view of a lampshade with the device of the first preferred embodiment being lifted to permit placement of the art overlay.

FIG. 6 is a sectional view of the device of the first preferred embodiment taken along line 6-6 of the FIG. 2.

FIG. 7 is a sectional view taken along line 7-7 of FIG. 2 with the device of the first preferred embodiment in open and closed positions.

FIG. 8 is a sectional view of the first preferred embodiment taken along line 8-8 of FIG. 2.

FIG. 9 is a front view of the device of the first preferred embodiment.

FIG. 10 is a sectional view taken along line 10-10 of FIG. 9 with the device of the first preferred embodiment in open and closed positions.

FIG. 11 is a cutaway view of a lampshade with the device of the second preferred embodiment.

FIG. 12 is a perspective view of a lampshade with the device of the second preferred embodiment.

FIG. 13 is a perspective view of a lampshade having an art overlay being partially held by the device of the second preferred embodiment.

FIG. 14 is a perspective view of the device of the third preferred embodiment.

FIG. 15 is a perspective view of a lampshade with the device of the third preferred embodiment.

FIG. 16 is a perspective view of a sconce lamp with the device of the fourth preferred embodiment of the present invention.

### DETAILED DESCRIPTION OF THE INVENTION

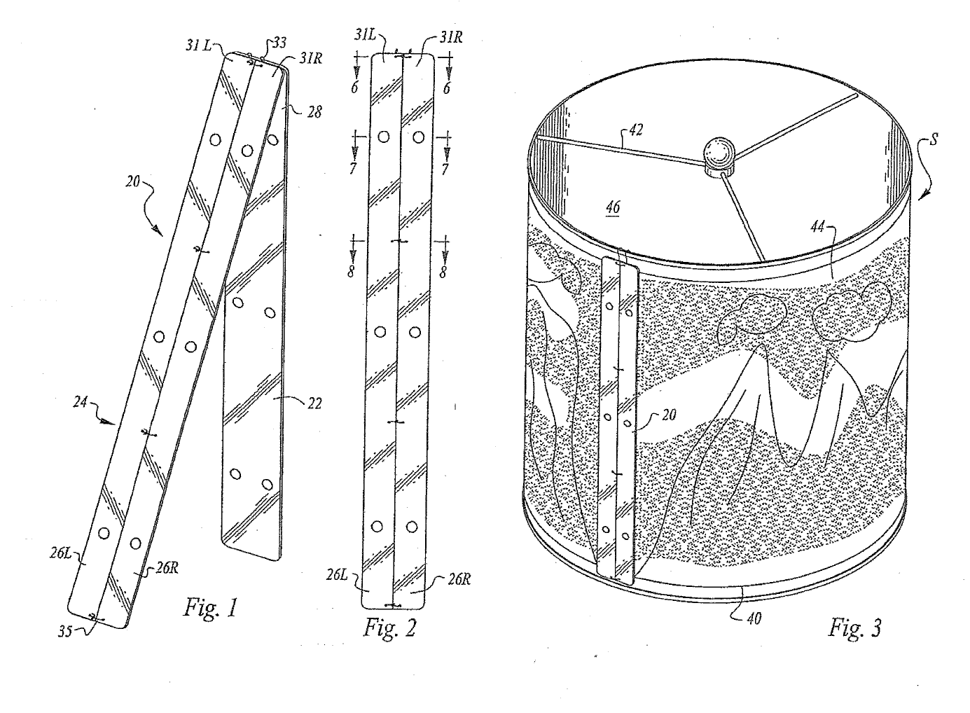

With reference to FIGS. 1-16, the preferred embodiments of the device of the present invention may be described. In a first preferred embodiment, as shown in FIGS. 1-10, the holder 20 is comprised of a series of opposed translucent, elongated panels. The panels preferably are made of plastic, but it should be understood that the panels may alternatively be made of other suitable materials (e.g. wood) that would be well-known to those skilled in the art. A rear panel 22 is designed to rest on the inner surface of a lighting cover S, while the front panel 24 is designed to rest on the outer surface of the lighting cover S. The lighting cover S may be a lampshade or any other exterior cover to a light source, such as the exterior surface of a sconce lamp or barrel lamp which are fully enclosed. The front panel 24 is divided into two longitudinally extending, parallel subpanel sections. One subpanel 26L is on the left and the other subpanel 26R is on the right. The left and right panels 26L, 26R are separated along a central longitudinal and essentially vertical axis and are intended to lay flat against the outer surface of the lighting cover S.

As shown FIGS. 1-2, the top region 31L, 31R of front panel 24 and the top region 28 of the rear panel 22 are hingeably tied to one another. The tie 33 itself is translucent, making the holder 20 as transparent as possible. The tie 33 connecting the front panel 24 and rear panel 22 is sufficiently tightened to allow only a very small amount of movement of the panels 22, 24 relative to one another. It should be appreciated that the tie 33 holding the front panel 24 and rear panel 22 could be eliminated entirely, but the absence of the tie makes aligning the front panel 24 and rear 22 more difficult. Further, a tie 35 joins the lower most position of the subpanel elements 26L, 26R and is of the same or similar material and flexibility as is found in tie 33. The left and right subpanels 26L, 26R of the front panel 24 are also hingeably connected to one another with ties 48, preferably in at least two places along their adjacent inner edges.

In one embodiment, the holder 20 functions in concert with a lampshade, which preferably includes a cover 40 circumscribing a wire frame 42. While the shape of the lampshade shown in FIG. 3 is cylindrical, the shape of the shade may be any shape that would be well-known to those skilled in the art, including rectangular and conical.

It is an essential function of the present invention to allow a decorative change in decor from time to time as may be desired. In order to accomplish such a change, the lampshade itself is provided with an art overlay 44 of a decorative, yet translucent, material upon which any one of many designs may be applied (e.g. flag design; designs for the Thanksgiving, Christmas and New Year holidays; mountain and/or desert scenes and stars designs, and designs for anniversaries and birthdays). The holder 20 is designed to secure the overlay 44 around the lampshade. As shown in FIGS. 3-5, the holder 20 is fitted over the lampshade such that the rear panel 22 is positioned against the inner surface 46 of the lampshade and is aligned with the front panel 24, which is fitted against the outer surface of the lampshade.

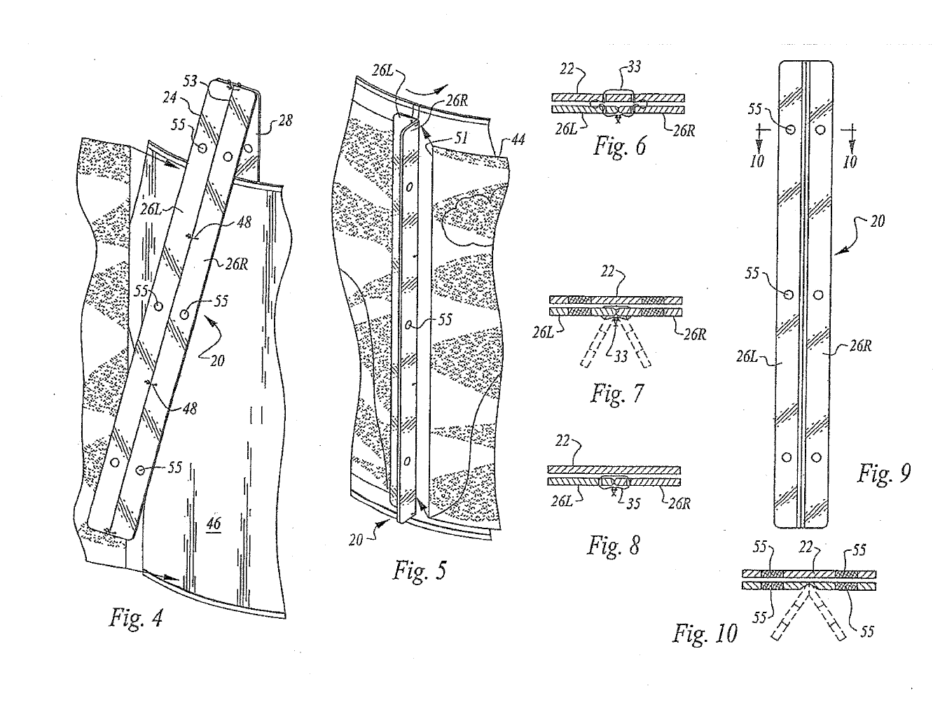

As shown in FIG. 4, the subpanels 26L, 26R of the front panel 24 are loosely connected by translucent ties 48, 50. While one of the subpanels remains flat against the lampshade, as shown in FIG. 5, the other may be independently flipped upward along its inner lengthwise edge. In so doing, one end 51 of the overlay 44 may then be fitted against the edge 53 of the subpanel remaining flat against the shade. In order to hold the front and rear panels 24, 22 against one another, magnets 55 are positioned on the panels. The magnets 55 preferably are neodymium magnets, but it should be understood that the magnets may alternatively be of other types that would be well-known to those skilled in the art. When the panels 22, 24 are flat against the lampshade, the north pole of the magnets on one of the panels is attracted to the south pole of the magnets 55 on the opposite panel and on the opposite surface of the shade. As a result of the attractions and resulting association between the complementary magnets 55, one end 51 of the overlay 44 becomes secure against the lampshade by being positioned between the magnets. The opposite edge of the overlay is then secured in the same manner, with the resulting overlay 44 completely circumscribing the lampshade with the design on the overlay becoming the change in decor. The overlay 44 may be quickly removed and another overlay installed without the use of tools or damaging the overlay. Thus, the removed overlay 44 can be stored and used again when desired.

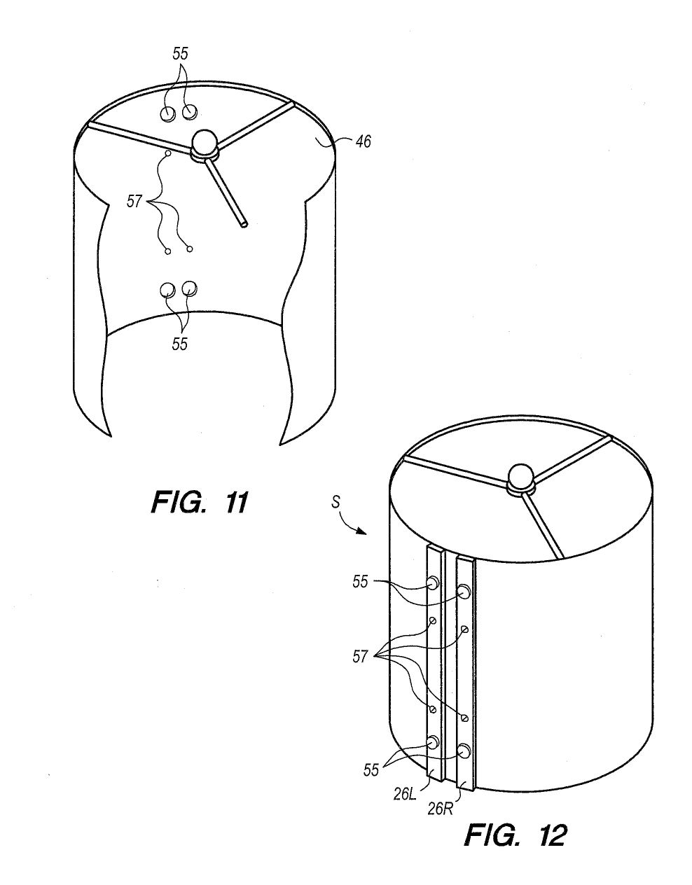

A second preferred embodiment of the holder 20 of the present invention is shown in FIGS. 11-13. In this embodiment, the holder 20 does not include a rear panel 22. Instead, the magnets 55 are attached directly to the inner surface 46 of the shade. The magnets 55 are preferably permanently attached to the inner surface 46 of the shade such as by gluing or other methods that would be well-known to those skilled in the art. These magnets 55 are complementary to the magnets 55 of the front panel 24. Like as described above in the first embodiment, the second preferred embodiment of the holder may or may not include ties 33, 35, 48 to join the front and rear panels 22, 24 or the subpanels 26L, 26R of the front panel 24. To assist in positioning the overlay 44 on the shade, registration pins 57 are attached to inner surface of the shade and protrude from the outer surface of the shade. The ends of the overlay 44 preferably include holes 61 for receiving the registration pins 57. Positioning the overlay 44 on the registration pins 57 guarantees proper alignment of the overlay 44 on the shade and alleviates the need to determine proper alignment solely by the naked eye. While the number of registration pins 57 may vary, the inventor has found two rows of two registration pins (four registration pins total) to be preferable in most instances. The subpanels 26L, 26R of the front panel 24 also include holes 59 for receiving the registration pins 57. In addition to alleviating the risk of misalignment of the holder during installation, the fixed position of the registration pins and the permanently attached magnets on the inner surface 46 of the shade alleviates the risk of the holder 20 and overlay 44 being knocked out of position after installation.

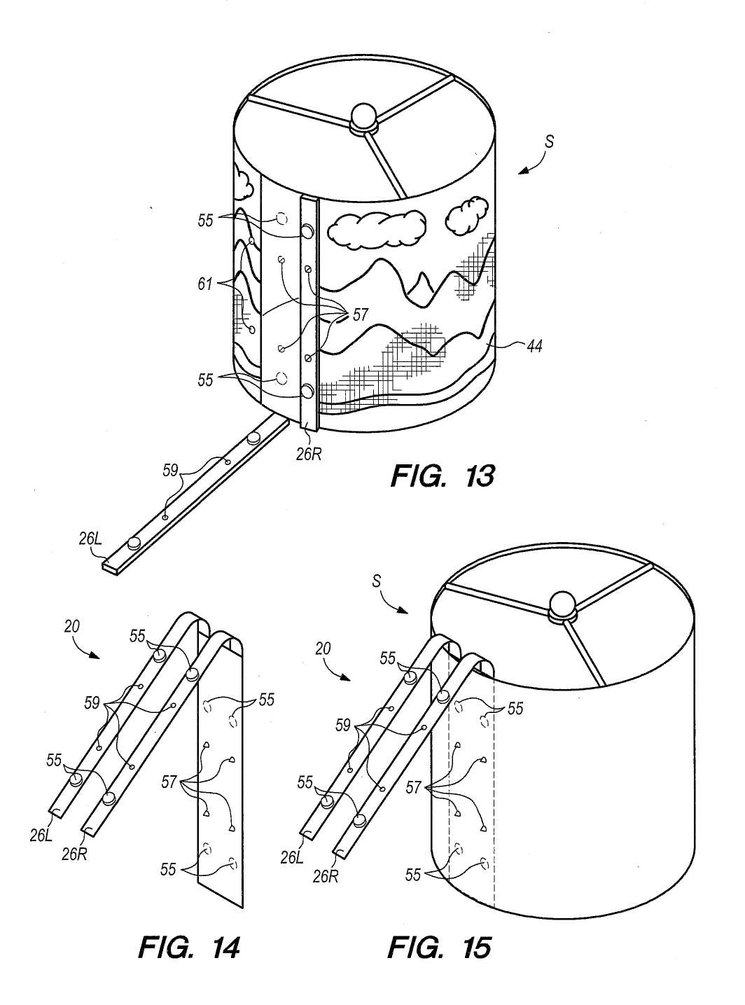

The front panel 24 preferably is permanently attached to the shade S at either the top or the bottom of the shade S. For example, as shown in FIG. 13, the subpanels 26L, 26R of the front panel 24 may be hinged to the inner surface of the shade, such as by gluing the front panel 24 to the shade. Other alternative manners of permanently attaching the front panel 24 to the shade may also be utilized so long as the subpanels 26L, 26R are still able to lay substantially flat on the outer surface of the shade S when in use. Permanently attaching the front panel 24 to the shade lessens the risk of the holder being damaged or lost if it was capable of being removed from the shade.

The process for using the holder of the second preferred embodiment in installing an art overlay may now be described. If the elements 26L, 26R of the front panel 24 are connected via ties 33, 35, 48, as described above, the overlay 44 is installed on the shade S by disassociating the complementary magnets 55 of the right subpanel 26R of the front panel and the corresponding magnets 55 of the inner surface of the shade by lifting the right edge of right subpanel 26R, as shown in FIG. 5. While the right edge of the subpanel 26R is lifted from the outer surface of the shade S (i.e. the right subpanel is converted to the open position), the holes 61 in the left end of the overlay 44 are positioned to receive the registration pins 57. The right subpanel 26R is pushed downward (i.e. the right subpanel is converted to the closed position) such that the registration pins are also received in the corresponding holes in the right subpanel 26R. Because of the attraction between the complementary magnets 55 of the right subpanel 26R and the magnets positioned on the inner surface of the shade, the right subpanel 26R may be self-positioned even without the registration pins. The right end of the overlay 44 is then wrapped around the shade until its approaches the left subpanel 26L. The process for positioning the right end of the overlay 44 is the same as described above for the left end by lifting the left subpanel 26L, positioning the art overlay on the registration pins, and closing the left subpanel.

If the elements 26L, 26R of the front panel 24 are hinged at the bottom of the shade, as described above and shown in FIG. 13, the overlay is installed on the shade by disassociating the complementary magnets 55 of the right subpanel 26R of the front panel and the magnets 55 of the inner surface of the shade by pulling the top of right subpanel 26R away from the shade (i.e. the right subpanel is converted to the open position). While the right subpanel 26R is pulled away from from the outer surface of the shade, the holes 61 in left end of the overlay 44 are positioned to receive the registration pins 57 and the right subpanel 26R is pushed towards to the shade until the registration pins 57 are received in the corresponding holes 59 in the right subpanel 26R (i.e. the right subpanel is converted to the closed position). Because of the attraction between the complementary magnets 55 of the right subpanel 26R and the magnets positioned on the inner surface of the shade, the right subpanel 26R may be self-positioned even without the registration pins. The right end of the overlay 44 is then wrapped around the shade S until its approaches the left subpanel 26L. The process for positioning the right end of the overlay 44 is the same as described above for the left end by lifting the left subpanel 26L, positioning the art overlay on the registration pins, and closing the left subpanel.

The holder 20 of the present invention is not limited to use on lampshades and may also be used on a barrel lamp. The barrel lamp has both a top and a bottom surface and thus the barrel lamp is completely enclosed. The holder is attached to the barrel lamp and functions in the same way as described above for a shade, where the front panel is positioned on the front surface of the barrel lamp and the complementary magnets are attached to the inside surface of the barrel lamp. In some applications, the subpanels 26R, 26L of the front panel 24 are each hinged to the front surface of the barrel lamp. The right subpanel 26R is preferably hinged along its right edge and the left subpanel 26L is preferably hinged along its left edge. The overlay 44 is installed on the barrel lamp S by disassociating the complementary magnets 55 of the right subpanel 26R of the front panel and the corresponding magnets 55 of the inner surface of the lamp by lifting the right edge of right subpanel 26R, similarly to as shown in FIG. 5 without hinges. While the right edge of the subpanel 26R is lifted from the outer surface of the barrel lamp S (i.e. the right subpanel is converted to the open position), the holes 61 in the left end of the overlay 44 are positioned to receive the registration pins 57. The right subpanel 26R is pushed downward (i.e. the right subpanel is converted to the closed position) such that the registration pins are also received in the corresponding holes in the right subpanel 26R. Because of the attraction between the complementary magnets 55 of the right subpanel 26R and the magnets positioned on the inner surface of the shade, the right subpanel 26R may be self-positioned even without the registration pins. The right end of the overlay 44 is then wrapped around the shade until its approaches the left subpanel 26L. The process for positioning the right end of the overlay 44 is the same as described above for the left end by lifting the left subpanel 26L, positioning the art overlay on the registration pins, and closing the left subpanel.

A third preferred embodiment of the present invention is shown in FIGS. 14-15. In this embodiment, the rear panel 22 is permanently attached (e.g. glued) to the inside surface 46 of the shade. There are preferably four magnets 55 attached to the rear panel 22, although the number of magnets used in all embodiments of the present invention will depend upon the size of the lighting cover. However, it should be understood that at least two complementary magnets must be utilized (one on the front panel and one on the rear panel). The magnets 55, for example, may be laminated to the surface of the rear panel 22. The rear panel 22 also preferably includes four registration pins protruding from its surface that are pushed into the inner surface of the shade and protrude from the outer surface of the shade S. The subpanels 26R, 26L of the front panel 24 are each attached to the rear panel 22 along an upper edge. The upper edge of the holder is positioned at the upper edge of the shade. The subpanels 26R, 26L are preferably spaced from one another. The subpanels 26R, 26L include magnets 55 complementary to those attached to the rear panel 22. In an alternative version of the third embodiment, the subpanels 26R, 26L of the front panel 24 are each attached to the rear panel 22 along a bottom edge. The bottom edge of the holder is positioned at the bottom edge of the shade.

The process for using the holder of the third preferred embodiment in installing an art overlay may now be described. The overlay 44 is installed on the shade by disassociating the complementary magnets 55 of the right subpanel 26R of the front panel and the corresponding magnets of the rear panel 22 by pulling the bottom of right subpanel 26R upward and away from the shade (i.e. the right subpanel is converted to the open position). If the alternative version of the third embodiment of the holder is being utilized, instead of pulling the bottom of the right subpanel 24 upward and away from the shade, the top of the right panel 24 is pulled downward and away from the shade. While the right subpanel 26R is pulled away from the outer surface of the shade, the holes 61 in left end of the overlay 44 are positioned to receive the registration pins 57 and the right subpanel 26R is pushed towards to the shade until that the registration pins are received in the corresponding holes in the right subpanel 26R (i.e. the right subpanel is converted to the closed position). Because of the attraction between the complementary magnets 55 of the right subpanel 26R and the magnets of the rear panel 22, the right subpanel 26R may be self-positioned even without the registration pins. The right end of the overlay 44 is then wrapped around the shade until its approaches the left subpanel 26L. The process for positioning the right end of the overlay 44 is the same as described above for the left end by lifting the left subpanel 26L (either the top or the bottom), positioning the art overlay on the registration pins, and closing the left subpanel.

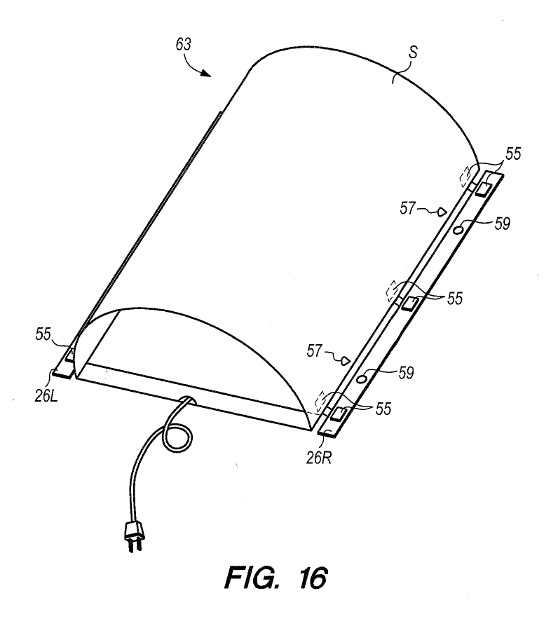

In a fourth embodiment of the present invention, which is shown in FIG. 16, the holder is used on a sconce lamp 63 which may be mounted on the wall. Because the sconce lamp is semi-circular, the subpanels 26R, 26L of the front panel 24 are positioned on opposite ends of the sconce lamp. The subpanels 26R, 26L are preferably hinged to the back surface of the sconce lamp. Complementary magnets 55 to those attached to the subpanels 26R, 26L are attached to the inner surface of the sconce lamp. As described above, registration pins 57 protrude from the outside surface of the sconce lamp, which are received through holes in the overlay 44 and the subpanels 26R, 26L of the front panel 24 when the overlay 44 is installed.

The process for using the holder of the fourth preferred embodiment in installing an art overlay may now be described. The overlay is installed on the sconce lamp by disassociating the complementary magnets 55 of the right subpanel 26R of the front panel and the corresponding magnets attached to the inner surface of the sconce lamp by lifting the right edge of right subpanel 26R (i.e. the right subpanel is converted to the open position). While the right end of the right subpanel 26R is lifted from the outer surface of the sconce lamp as shown in FIG. 16, the holes 61 in right end of the overlay 44 are positioned to receive the registration pins 57. The right subpanel 26R is then pushed downward towards the surface of the sconce lamp (i.e. the right subpanel is converted to closed position) such that the registration pins are received in the corresponding holes 59 in the right subpanel 26R. Because of the attraction between the complementary magnets 55 of the right subpanel 26R and the corresponding magnets positioned on the inner surface of the sconce lamp, the right subpanel 26R may be self-positioned even without the registration pins. The left end of the overlay 44 is then stretched across the front surface the sconce lamp until its approaches the left subpanel 26L. The process for positioning the left end of the overlay 44 is the same as described above for the right end by lifting the left subpanel 26L, positioning the art overlay on the registration pins, and closing the left subpanel.

The present invention has been described with reference to certain preferred and alternative embodiments that are intended to be exemplary only and not limiting to the full scope of the present invention.

We claim:

1. A device for securing an art overlay to a lighting cover, comprising:
a front panel configured for positioning on an outside surface of a lighting cover, wherein said front panel comprises a first subpanel and second subpanel, wherein a first magnet is attached to said first subpanel and a second magnet is attached to said second subpanel, wherein said front panel is liftable to secure an art overlay to a lighting cover;
a third magnet, wherein said third magnet is complementary to said first magnet, wherein said third magnet is configured for attachment to an inside surface of a lighting cover; and
a fourth magnet, wherein said fourth magnet is complementary to said second magnet, wherein said fourth magnet is configured for attachment to an inside surface of a lighting cover.

2. The device of claim 1, wherein said first subpanel is attached to said second subpanel.

3. The device of claim 1, wherein said front panel is attached to a hinge.

4. A device for securing an art overlay to a lighting cover, comprising a front panel comprising a first subpanel and a second subpanel, wherein a first magnet is attached to said first subpanel and a second magnet is attached to said second subpanel, wherein said front panel contacts an outside surface of a lighting cover, wherein said front panel is liftable to secure an art overlay to said outside surface of said lighting cover;
a third magnet, wherein said third magnet is in contact with an inside surface of said lighting cover, wherein said third magnet is complementary to said first magnet; and
a fourth magnet, wherein said fourth magnet is in contact with said inside surface of said lighting cover, wherein said fourth magnet is complementary to said second magnet.

5. The device of claim 4, wherein said first subpanel is attached to said second subpanel.

6. The device of claim 4, wherein said lighting cover is a lampshade.

7. The device of claim 4, wherein said lighting cover is an external surface of a fully-enclosed lamp.

8. The device of claim 4, wherein said front panel is hinged to said lighting cover.

9. The device of claim 4, wherein said outside surface of said lighting cover comprises a first registration pin and a second registration pin.

10. The device of claim 9, wherein an art overlay is positioned on said outside surface of said lighting cover.

11. The device of claim 10, wherein said art overlay comprises a first opening and a second opening, wherein said first registration pin is received through said first opening in said art overlay and said second registration pin is received through said second opening in said art overlay.

12. The device of claim 9, wherein said first subpanel comprises a first opening and said second subpanel comprises a second opening, wherein said first registration pin is received through said first opening in said first subpanel and said second registration pin is received through said second opening in said second subpanel.

13. The device of claim 4, wherein said third magnet and said fourth magnet are attached to a rear panel.

14. The device of claim 13, wherein said rear panel comprises a registration pin.

15. The device of claim 13, wherein a top of said front panel is attached to a top of said rear panel.

16. The device of claim 13, wherein a bottom of said front panel is attached to a bottom of said rear panel.
